(19) United States
(12) Patent Application Publication
(10) Pub. No.: US 2026/0097711 A1
(43) Pub. Date: Apr. 9, 2026

(54) DRAWER STORAGE SYSTEM FOR A VEHICLE HAVING RECESSED ANCHORS

(71) Applicant: Brian Fulton, Westminster, CA (US)

(72) Inventor: Brian Fulton, Westminster, CA (US)

(21) Appl. No.: 18/907,451

(22) Filed: Oct. 4, 2024

(51) Int. Cl. B60R 5/04

(52) U.S. Cl. CPC B60R 5/04

(57) ABSTRACT

A drawer system for a vehicle. Flooring is rigidly connected to a storage system frame. The flooring includes cutout sections that allow for anchor connection to the frame through the cutout sections. Consequently, anchors are then recessed below the surface of the flooring.

The present invention relates to storage systems for vehicles, and, in particular, to anchors for the vehicle storage systems.

### BACKGROUND OF THE INVENTION

Drawer storage systems for vehicles are known in the prior art. For example, FIG. 1 shows van 1 having drawer storage system 2. Drawer storage system 2 includes slidable storage drawers 3 and 4, storage system frame 5, and flooring 6. Typically, flooring 6 is bolted to frame 5 during the installation of drawer storage system 2. For greater stability while transporting gear resting on flooring 6, owners will often attach anchors to flooring 6. As shown in FIG. 2, anchors 7 are bolted to the top of flooring 6. Straps 8 are then connected to anchors 7 via hook 9. Straps 8 allow the user to securely tie down other gear as necessary to prevent the gear from moving and sliding across flooring 6 while van 1 is being driven.

Unfortunately, however, anchors 7 extend above the surface of flooring 6, as shown. This is undesirable when transporting gear that is not secured with straps. For example, anchors 7 extending above flooring 6 can cut into or otherwise damage gear that is not tied down.

What is needed is a better way to secure anchors to a drawer storage system for vehicles.

### SUMMARY OF THE INVENTION

The present invention provides a drawer system for a vehicle. Flooring is rigidly connected to a storage system frame. The flooring includes cutout sections that allow for anchor connection to the frame through the cutout sections. Consequently, anchors are then recessed below the surface of the flooring.

### BRIEF DESCRIPTION OF THE DRAWINGS

FIGS. 1 and 2 show a prior art drawer storage system for a vehicle.

FIGS. 3-6 show a preferred embodiment of the present invention.

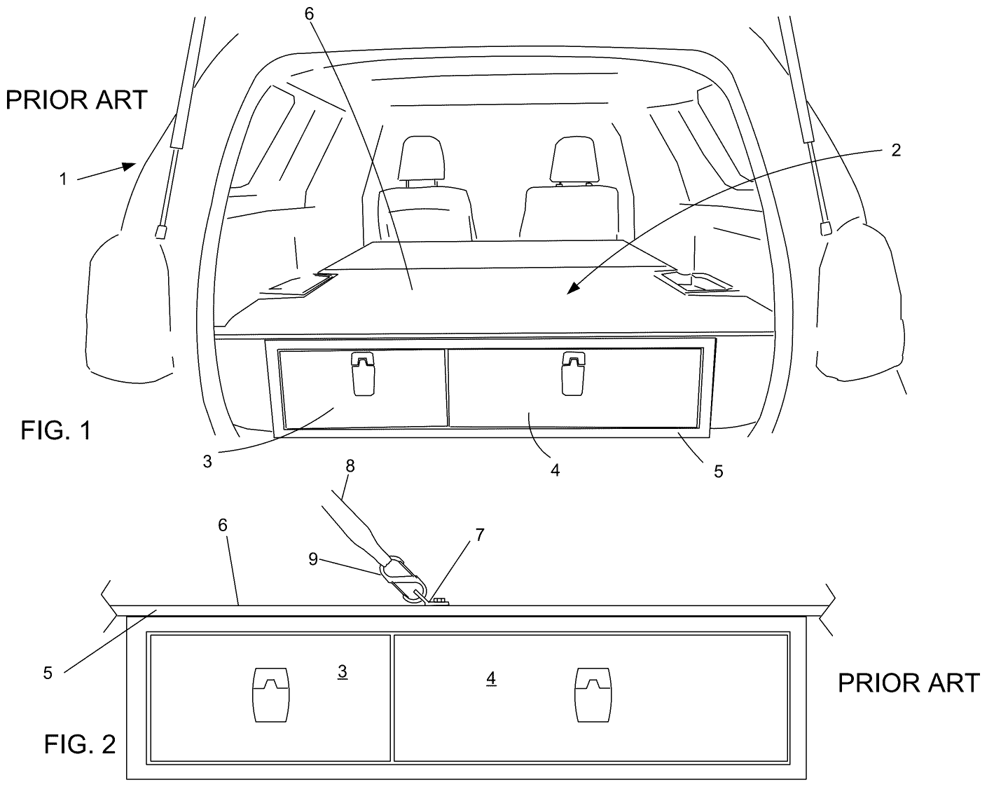

### DETAILED DESCRIPTION OF THE PREFERRED EMBODIMENTS

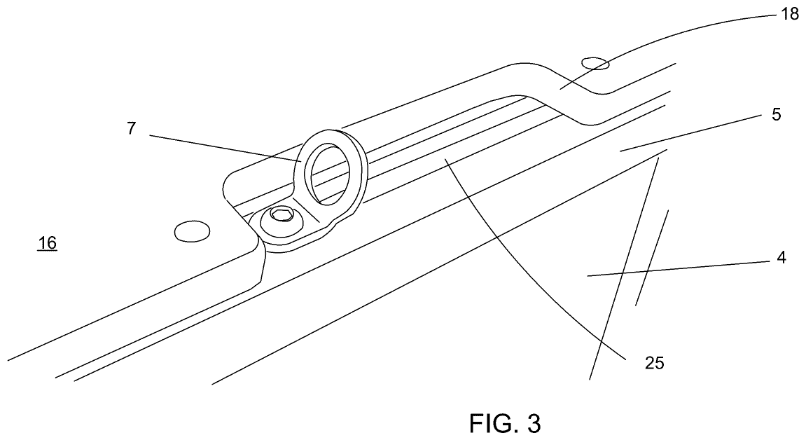

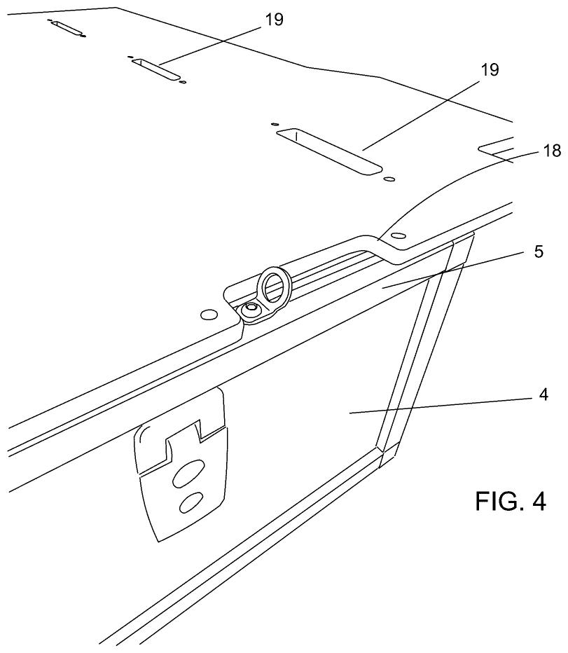

FIGS. 3 and 4 show a preferred embodiment of the present invention. In FIG. 3, flooring 16 includes edge frame cutout sections 18 and interior cutout sections 19. The cutout sections allow access to frame 5 for anchor installation directly to frame 5, as shown. For example, in FIGS. 3 and 4, anchor 7 has access to frame 5 through edge cutout section 18 and is bolted directly to frame 5. This allows for anchor 7 to sit below the surface of flooring 16. Now, gear may be placed on the surface of flooring 16 without fear of the gear being damaged by a protruding anchor.

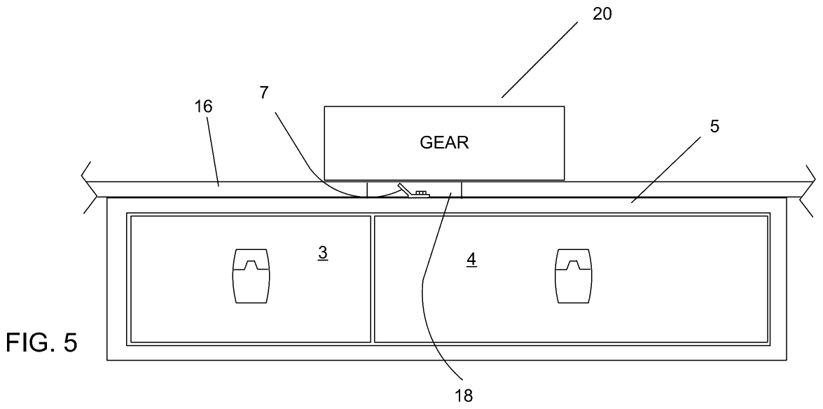

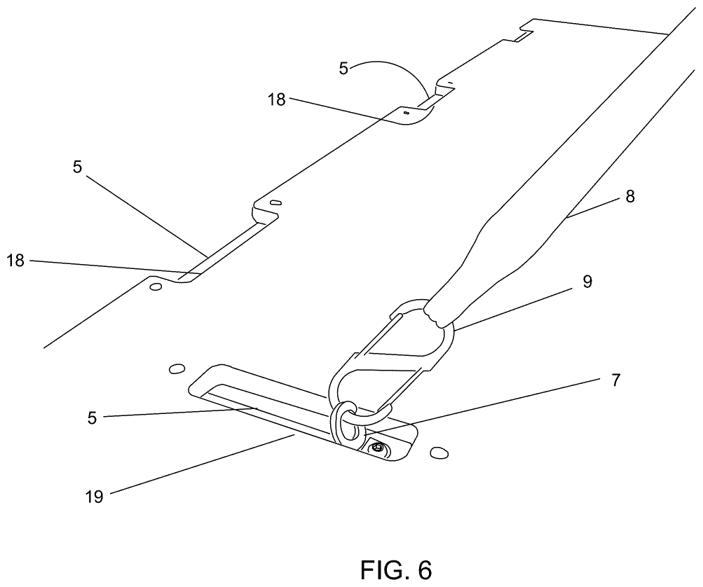

For example, FIG. 5 shows recessed anchor 7 bolted directly to frame 5 via edge cutout section 18. Gear 20 is resting on flooring 16 and is not being damaged by a protruding anchor. FIG. 6 shows strap 8 connected to anchor 7. In FIG. 6, anchor 7 is bolted directly to frame 5 through interior cutout section 19. In a preferred embodiment frame 5 includes horizontal groove 25. Anchors 7 are bolted to frame 5 through horizontal groove 25. This allows for greater flexibility in the precise positioning of anchors 7.

Although the above preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A drawer storage system for a vehicle, comprising:
A. a storage system frame,
B. flooring rigidly connected to the surface of said storage system frame, comprising:
i. at least one cutout section allowing anchor access to said storage system frame, and
C. at least one anchor rigidly attached to said storage system frame,
wherein said at least one anchor is attached that at a portion of said anchor is recessed below said flooring surface.

2. The drawer storage system as in claim 1, further comprising at least one drawer slidingly connected to said storage system frame.

3. The drawer storage system as in claim 1, wherein said drawer storage system is rigidly connected to the interior of a vehicle.

4. The drawer system as in claim 1, wherein said at least one cutout section is a plurality of cutout sections comprising a plurality of edge cutout sections and a plurality of interior cutout sections.

5. The drawer system as in claim 1, wherein a strap is removably connected to said at least one anchor.
